(19) United States
(12) Patent Application Publication
(10) Pub. No.: US 2026/0280105 A1
(43) Pub. Date: Sep. 17, 2026

(54) ELECTRONIC DEVICE

(71) Applicant: HONOR DEVICE CO., LTD., Shenzhen (CN)

(72) Inventors: Wenlong Hu, Shenzhen (CN); Qing Xia, Shenzhen (CN); Kai Liu, Shenzhen (CN); Shanzeng Zhang, Shenzhen (CN)

(73) Assignee: HONOR DEVICE CO., LTD., Shenzhen (CN)

(21) Appl. No.: 19/675,598

(22) Filed: May 13, 2026

Related U.S. Application Data
(63) Continuation of application No. PCT/CN2024/107738, filed on Jul. 26, 2024.

(30) Foreign Application Priority Data
Nov. 25, 2023 (CN) 202311591999.7

(51) Int. Cl. H01Q 1/24

(52) U.S. Cl. CPC H01Q 1/243

(57) ABSTRACT

An electronic device including a housing, first and second buttons, first and second circuit boards, an antenna, and a device circuit board. The antenna includes a radiator and a feeding portion, both integrally formed with the housing and fastened together. The buttons, circuit boards, and feeding portion are disposed inside the housing. In a first direction, the first and second circuit boards respectively connect the first and second buttons to the device circuit board. In a perpendicular second direction, the feeding portion is disposed between the spaced-apart first and second buttons, electrically connected to the device circuit board, and spaced apart from both the first and second circuit boards. The antenna does not need to be fitted, and has a strong radiation intensity.

### CROSS-REFERENCE TO RELATED APPLICATIONS

This application is a continuation of International Application No. PCT/CN2024/107738, filed on Jul. 26, 2024, which claims priority to Chinese Patent Application No. 202311591999.7, filed on Nov. 25, 2023, both of which are incorporated herein by reference in their entireties.

### TECHNICAL FIELD

This application relates to the field of electronic product technologies, and in particular, to an electronic device.

### BACKGROUND

As requirements for frequency bands supported by an electronic device and for signals transmitted or received by the electronic device increase, there are increasingly high requirements for a radiation intensity of an antenna. However, an antenna in a current electronic device is troublesome to fit, and has a weak radiation intensity.

### SUMMARY

This application provides an electronic device, in which an antenna does not need to be fitted, and has a strong radiation intensity.

This application provides an electronic device. The electronic device includes a housing, a first button, a second button, a first circuit board, a second circuit board, an antenna, and a device circuit board; the antenna includes a radiator and a feeding portion, and the radiator and the feeding portion are both integrally formed with the housing; and the first button, the second button, the first circuit board, the second circuit board, the feeding portion, and the device circuit board are all disposed inside the housing.

The electronic device may be a foldable phone. The mobile phone includes a first housing and a second housing. The first housing and the second housing are rotatably connected. The foregoing housing may be the first housing or the second housing. The electronic device may alternatively be a bar phone.

The first button may be a volume increasing button, and the second button may be a volume decreasing button. A radio frequency chip and a control chip may be integrated on the device circuit board. The radio frequency chip is configured to be electrically connected to the feeding portion. A signal transmitted by the radio frequency chip may be transmitted to the feeding portion, the feeding portion then transmits the signal to the radiator, and the radiator transmits the signal. In this way, the electronic device can send signals. A signal received by the radiator may be transmitted to the feeding portion, and the signal received by the feeding portion may be transmitted to the radio frequency chip. In this way, the electronic device can receive signals.

The control chip is configured to be electrically connected to the first button through the first circuit board and to be electrically connected to the second button through the second circuit board. After the first button is pressed, the control chip may control the volume of the electronic device to increase. After the second button is pressed, the control chip may control the volume of the electronic device to decrease.

In a first direction, two sides of the first circuit board are respectively connected to the first button and the device circuit board, and two sides of the second circuit board are respectively connected to the second button and the device circuit board. In a second direction, the second direction is perpendicular to the first direction, the first button and the second button are spaced apart, the feeding portion is disposed between the first button and the second button and electrically connected to the device circuit board, the first circuit board and the feeding portion are spaced apart, and the second circuit board and the feeding portion are spaced apart. In this way, at least a part is exposed between the feeding portion and the first circuit board, and at least a part is also exposed between the feeding portion and the second circuit board, further avoiding the first circuit board and the second circuit board affecting a signal radiation intensity of the feeding portion. As such, signals radiated by the feeding portion are strong in intensity, improving a radiation intensity of the antenna.

In some embodiments, in the second direction, a distance between the first circuit board and the feeding portion is at least 0.8 millimeter, and a distance between the second circuit board and the feeding portion is at least 0.8 millimeter. Therefore, there is adequate clearance between the first circuit board and the feeding portion, and there is also adequate clearance between the second circuit board and the feeding portion. As such, radiation performance of the feeding portion can be better leveraged.

In some embodiments, the housing includes a border frame and a supporting piece, and the border frame surrounds and is fastened on a periphery of the supporting piece; and at least a part of the supporting piece forms the feeding portion, and at least a part of the border frame forms the radiator. While being a frame and an exterior part of the mobile phone, the border frame may serve as the radiator, saving components, simplifying assembly steps, increasing assembly efficiency, and improving the radiation intensity of the antenna. The feeding portion is integrally formed with the supporting piece, enhancing structural strength of the supporting piece, saving components, simplifying the assembly steps, and increasing assembly efficiency. In addition, because a part of the border frame serves as the radiator, at least a part of the radiator can be an exterior surface of the mobile phone, that is, at least a part of the radiator is exposed on the outside and is visible. Therefore, this can not only avoid the radiator occupying internal space of the mobile phone, but also avoid another component in the electronic device blocking the radiator. As such, the antenna has a stronger radiation intensity.

In some embodiments, the border frame includes a first border frame, and at least a part of the first border frame forms the radiator; the radiator is provided with a first through-hole and a second through-hole, and in the first direction, the first through-hole and the second through-hole both run through the radiator; the electronic device further includes a first button cap and a second button cap, the first button cap is mounted into the first through-hole, and the first button cap is fastened to the first button; and the second button cap is mounted into the second through-hole, and the second button cap is fastened to the second button.

In a related technology, as a mobile phone needs to support an increasing quantity of frequency bands, a corresponding quantity of antennas is increasing, and space required for disposing the antennas is also growing. However, an increase in the quantity of antennas goes against a trend of making the mobile phone thinner and lighter. For a purpose of meeting a requirement for the quantity of antennas, portions that are of a border frame of the mobile phone and at which no other components are disposed are also used as radiators of the antennas. Correspondingly, feeding portions connected to the antennas are disposed in spare positions on a supporting piece. However, the quantity of antennas still cannot meet the requirement.

In this embodiment, for a purpose of resolving the foregoing problem, regions that are of the border frame and that are used for mounting the first button cap and the second button cap are also utilized. More specifically, regions that are of the first border frame and in which the first button cap and the second button cap are disposed are utilized for disposing the radiator, and regions that are of the supporting piece and in which a first button module and a second button module are mounted are utilized for disposing the feeding portion. In this way, the radiators can be electrically connected to the radio frequency chip on the device circuit board through the feeding portions, implementing functions of the antennas. As such, not only a quantity of the antennas can be increased, but also the antennas can be prevented from compromising a design of making the mobile phone thinner and lighter.

In some embodiments, the first button cap and the second button cap are both made of metal. Therefore, the first button cap and the second button cap provide a good operating feel. Outer surfaces of the first button cap and the second button cap are both provided with an insulating layer, so that the first button cap and the second button cap are insulated from each other, further preventing the first button cap and the second button cap from compromising radiation performance of the radiator.

In some embodiments, the first through-hole and the second through-hole communicate to form a communicating hole, and the first button cap and the second button cap are integrally formed. In this way, machining is easy, and the first button cap and the second button cap can be easily mounted into the communicating hole together, increasing assembly efficiency. In addition, there is a strong aesthetic appeal.

In some embodiments, the radiator operates in intermediate-frequency and high-frequency bands, a length of the communicating hole in the first direction is between 15 millimeters and 25 millimeters, and a width of the communicating hole in the first direction is between 1.2 millimeters and 1.8 millimeters. If the length or width of the communicating hole is excessively small, accordingly, for a purpose of enabling the first button cap and the second button cap to be smoothly mounted into the communicating hole, volumes of the first button cap and the second button cap need to be reduced. However, if the volumes of the first button cap and the second button cap are excessively small, it makes it difficult for a user to operate. If the length or width of the communicating hole is excessively large, a volume of the radiator may be small, resulting in a decrease in radiation performance of the radiator. When the length of the communicating hole is set to be between 15 millimeters and 25 millimeters and the width of the communicating hole is set to be between 1.2 millimeters and 1.8 millimeters, not only the communicating hole can accommodate the first button cap and the second button cap that are easy for a user to operate, but also impact of the communicating hole on radiation performance of the radiator can be reduced.

In some embodiments, a housing portion and an accommodating portion are provided inside the housing, and in the first direction, the border frame, the housing portion, and the accommodating portion are arranged sequentially; the housing portion includes a first housing portion and a second housing portion, and in the second direction, the first housing portion, the feeding portion, and the second housing portion are arranged sequentially; and the first button is disposed in the first housing portion, the second button is disposed in the second housing portion, and the device circuit board is disposed in the accommodating portion.

With the housing portion and the accommodating portion arranged in the first direction, the first housing portion, the feeding portion, and the second housing portion arranged in the second direction, the first button then disposed in the first housing portion, and the second button disposed in the second housing portion, the first button and the second button are separated by the feeding portion in the second direction. In this way, the first circuit board can be connected to the first button and the device circuit board along shortest paths, and can avoid the feeding portion, avoiding the first circuit board interfering with the feeding portion when being connected to the first button and the device circuit board; and the second circuit board can be connected to the second button and the device circuit board along shortest paths, and can avoid the feeding portion, avoiding the second circuit board interfering with the feeding portion when being connected to the second button and the device circuit board.

In some embodiments, the supporting piece further includes a connective portion, and in the first direction, the border frame, the connective portion, and the feeding portion are connected sequentially; in the second direction, a surface of the first housing portion, a surface of the connective portion, and a surface of the second housing portion are connected sequentially and are flush with each other, to form a sealing surface; and the electronic device further includes a sealing piece, and a surface of a side of the sealing piece is connected to the sealing surface. The sealing piece may be foam. When the electronic device is assembled, a backplane is fastened to the border frame, to seal components such as the device circuit board in the housing, preventing foreign objects such as dust from entering the housing.

In some embodiments, the first circuit board is a flexible circuit board, and the first circuit board includes a first connecting portion, a first flexible portion, and a second connecting portion that are connected sequentially; the first connecting portion is disposed in the first housing portion, and the second connecting portion is disposed in the accommodating portion; in the first direction, the first connecting portion and the first button are stacked and connected; and in a third direction, the second connecting portion and the device circuit board are stacked and connected. The first connecting portion is configured to be connected to the first button, and the second connecting portion is configured to be connected to the device circuit board. Because the first flexible portion can deform, the first circuit board can be smoothly connected to the first button and the device circuit board, and occupies small space.

In this embodiment, the first circuit board is a flexible circuit board and is used to connect the first button and the radio frequency chip of the device circuit board. With the first circuit board being thin, a volume of the first button module can be reduced, to save internal space of the first housing. In addition, because the first circuit board can deform, relative positions of the radio frequency chip and the first button can be flexible. Specifically, the first button and the first connecting portion can be stacked in the first direction, and the second connecting portion and the device circuit board can be stacked in the third direction. In other words, electrical connection between the radio frequency chip and the first button can be implemented through deformation of the first circuit board, regardless of how the relative positions of the radio frequency chip and the first button change. Furthermore, because the first circuit board can deform, the first circuit board can press against a corresponding portion of the first housing, reducing space occupied by the first circuit board, increasing structural compactness of the assembled first button module, and further saving the internal space of the first housing.

In some embodiments, the first housing portion is provided with a first housing groove, and the first connecting portion and the first button are both disposed in the first housing groove; and the electronic device further includes a first reinforcing plate, the first reinforcing plate is disposed in the first housing groove, a surface of the first reinforcing plate is stacked on and connected to a surface that is of the first connecting portion and that faces away from the first button, and a surface that is of the first reinforcing plate and that faces away from the first connecting portion is fastened to a groove side of the first housing groove. The first reinforcing plate is connected to the first connecting portion, to support the first connecting portion and enhance structural strength of the first connecting portion, increasing reliability of connection between the first connecting portion and the first button.

In some embodiments, a first fixing protrusion protrudes from a side that is of the first reinforcing plate and that is located at an opening of the first housing groove, and a first fixing groove is recessed into the groove side of the first housing groove; and the first fixing protrusion is fastened into the first fixing groove, to restrict the first reinforcing plate from shifting in the second direction. The first button is located in the housing. Correspondingly, the first button cap is mounted at the border frame of the housing. The first button cap is configured for a user to press. Pressure acts on the first button through the first button cap. A signal change generated by the first button is transmitted to the control chip through the first circuit board. After receiving the signal, the control chip controls the volume of the mobile phone to increase.

The first fixing protrusion fixes the first reinforcing plate in place in the second direction. Because the first button is fastened to the first reinforcing plate, the first fixing protrusion also fixes the first button in place in the second direction. Further, this can avoid the first button and the first button cap being misaligned in the second direction, increase precision of positions of the first button and the first button cap in the second direction, and improve smoothness that corresponds to a case in which the first button cap is pressed.

In some embodiments, a second fixing protrusion protrudes from a side that is of the first reinforcing plate and that faces a groove bottom of the first housing groove, the groove bottom of the first housing groove is provided with a first fixing hole, and a second fixing groove is recessed into a hole wall of the first fixing hole; and the second fixing protrusion extends into the first fixing hole and is fastened into the second fixing groove, to restrict the first reinforcing plate from shifting in the third direction. In this way, this can avoid the first button and the first button cap being misaligned in the third direction, increase precision of positions of the first button and the first button cap in the third direction, and improve smoothness that corresponds to a case in which the first button cap is pressed.

In some embodiments, a first handle protrusion also protrudes from the side that is of the first reinforcing plate and that is located at the opening of the first housing groove, and the first handle protrusion extends out of the first housing groove. When the first button, the first connecting portion of the first circuit board, and the first reinforcing plate need to be fitted into the first housing groove, an operator may hold the first handle protrusion, and mount the first reinforcing plate into the first housing groove from the opening of the first housing groove. Because the first button and the first connecting portion are both fastened to the first reinforcing plate, the first button and the first connecting portion are also mounted into the first housing groove together with the first reinforcing plate. After the fitting is completed, at least a part of the first handle protrusion is located outside the first housing groove. Then, the operator may break off the first handle protrusion from the first reinforcing plate, so that the first handle protrusion is separated from the first reinforcing plate. In this way, during the mounting, the first handle protrusion may be held by the operator, and after the mounting is completed, the first handle protrusion is broken off, preventing the first handle protrusion from occupying space and affecting fitting of other components.

In some embodiments, the accommodating portion is provided with an accommodating cavity, a first accommodating groove is recessed into a cavity bottom of the accommodating cavity, the device circuit board is disposed in the accommodating cavity, and the second connecting portion is disposed in the first accommodating groove. With the second connecting portion disposed in the first accommodating groove, the space inside the housing is fully utilized, and the second connecting portion can be prevented from protruding and pressing against the device circuit board. As such, stability of the device circuit board can be increased, and the second connecting portion can be smoothly connected to the device circuit board.

In some embodiments, the electronic device further includes a second reinforcing plate, the second reinforcing plate is disposed in the first accommodating groove, and the second reinforcing plate is stacked on a surface that is of the second connecting portion and that faces away from the device circuit board. The second reinforcing plate supports and reinforces the second connecting portion, helping the second connecting portion be mounted into the first mounting groove, and increasing stability of connection between the second connecting portion and the device circuit board.

In some embodiments, the second circuit board is a flexible circuit board, and the second circuit board includes a third connecting portion, a second flexible portion, and a fourth connecting portion that are connected sequentially; the third connecting portion is disposed in the second housing portion, and the fourth connecting portion is disposed in the accommodating portion; in the first direction, the third connecting portion and the second button are stacked and connected; and in the third direction, the fourth connecting portion and the device circuit board are stacked and connected. The third connecting portion is configured to be connected to the second button, and the fourth connecting portion is configured to be connected to the device circuit board. Because the second flexible portion can deform, the second circuit board can be smoothly connected to the second button and the device circuit board, and occupies small space.

The second circuit board is a flexible circuit board and is used to connect the second button and the radio frequency chip of the device circuit board. With the second circuit board being thin, a volume of the second button module can be reduced, to save the internal space of the first housing. In addition, because the second circuit board can deform, relative positions of the radio frequency chip and the second button can be flexible. Specifically, the third connecting portion and the second button can be stacked in the first direction, and the fourth connecting portion and the device circuit board can be stacked in the third direction. In other words, electrical connection between the radio frequency chip and the second button can be implemented through deformation of the second circuit board, regardless of how the relative positions of the radio frequency chip and the second button change. Furthermore, because the second circuit board can deform, the second circuit board can press against a corresponding portion of the first housing, reducing space occupied by the second circuit board, increasing structural compactness of the assembled second button module, and further saving the internal space of the first housing.

In some embodiments, the second housing portion is provided with a second housing groove, and the third connecting portion and the second button are both disposed in the second housing groove; and the electronic device further includes a third reinforcing plate, the third reinforcing plate is disposed in the second housing groove, a surface of the third reinforcing plate is stacked on and connected to a surface that is of the third connecting portion and that faces away from the second button, and a surface that is of the third reinforcing plate and that faces away from the third connecting portion is fastened to a groove side of the second housing groove. The third reinforcing plate is connected to the third connecting portion, to support the third connecting portion and enhance structural strength of the third connecting portion, increasing reliability of connection between the third connecting portion and the second button.

In some embodiments, a third fixing protrusion protrudes from a side that is of the third reinforcing plate and that is located at an opening of the second housing groove, and a third fixing groove is recessed into the groove side of the second housing groove; and the third fixing protrusion is fastened into the third fixing groove, to restrict the third reinforcing plate from shifting in the second direction. The second button is located in the housing. Correspondingly, the second button cap is mounted at the border frame of the housing. The second button cap is configured for a user to press. Pressure acts on the second button through the second button cap. A signal change generated by the second button is transmitted to the control chip through the second circuit board. After receiving the signal, the control chip controls the volume of the mobile phone to decrease. The third fixing protrusion fixes the third reinforcing plate in place in the third direction. Because the second button is fastened to the third reinforcing plate, the second fixing protrusion also fixes the second button in place in the second direction. Further, this can avoid the second button and the second button cap being misaligned in the second direction, increase precision of positions of the second button and the second button cap in the second direction, and improve smoothness that corresponds to a case in which the second button cap is pressed.

In some embodiments, a fourth fixing protrusion protrudes from a side that is of the third reinforcing plate and that faces a groove bottom of the second housing groove, the groove bottom of the second housing groove is provided with a second fixing hole, and a fourth fixing groove is recessed into a hole wall of the second fixing hole; and the fourth fixing protrusion extends into the second fixing hole and is fastened into the fourth fixing groove, to restrict the third reinforcing plate from shifting in the third direction. In this way, this can avoid the second button and the second button cap being misaligned in the third direction, increase precision of positions of the second button and the second button cap in the third direction, and improve smoothness that corresponds to a case in which the second button cap is pressed.

In some embodiments, a second handle protrusion also protrudes from the side that is of the third reinforcing plate and that is located at the opening of the second housing groove, and the second handle protrusion extends out of the second housing groove. When the second button, the third connecting portion of the second circuit board, and the third reinforcing plate need to be fitted into the second housing groove, an operator may hold the second handle protrusion, and mount the third reinforcing plate into the second housing groove from the opening of the second housing groove. Because the second button and the third connecting portion are both fastened to the third reinforcing plate, the second button and the third connecting portion are also mounted into the second housing groove together with the third reinforcing plate. After the fitting is completed, at least a part of the second handle protrusion is located outside the second housing groove. Then, the operator may break off the second handle protrusion from the third reinforcing plate, so that the second handle protrusion is separated from the third reinforcing plate. In this way, during the mounting, the second handle protrusion may be held by the operator, and after the mounting is completed, the second handle protrusion is broken off, preventing the second handle protrusion from occupying space and affecting fitting of other components.

In some embodiments, the accommodating portion is provided with an accommodating cavity, a second accommodating groove is recessed into a cavity bottom of the accommodating cavity, the device circuit board is disposed in the accommodating cavity, and the fourth connecting portion is disposed in the second accommodating groove. With the fourth connecting portion disposed in the second accommodating groove, the space inside the housing is fully utilized, and the fourth connecting portion can be prevented from protruding and pressing against the device circuit board. As such, stability of the device circuit board can be increased, and the fourth connecting portion can be smoothly connected to the device circuit board.

In some embodiments, the electronic device further includes a fourth reinforcing plate, the fourth reinforcing plate is disposed in the second accommodating groove, and the fourth reinforcing plate is stacked on a surface that is of the fourth connecting portion and that faces away from the device circuit board. The fourth reinforcing plate supports and reinforces the fourth connecting portion, helping the fourth connecting portion be mounted into the second mounting groove, and increasing stability of connection between the fourth connecting portion and the device circuit board.

### BRIEF DESCRIPTION OF DRAWINGS

To describe the technical solution in embodiments or in the background of this application more clearly, the following describes accompanying drawings that need to be used in embodiments or in the background of this application.

FIG. 1 is a diagram of a mobile phone in a first state according to an embodiment of this application;

FIG. 2 is a diagram of a mobile phone in a second state according to an embodiment of this application;

FIG. 3 is a diagram of a structure of a first housing of the mobile phone shown in FIG. 2;

FIG. 4 is a diagram of a partial structure of a first middle frame shown in FIG. 3;

FIG. 5 is a diagram of the partial structure of the first middle frame shown in FIG. 3 from another viewing angle;

FIG. 6 is a diagram of a partial structure of the mobile phone shown in FIG. 2;

FIG. 7 is a diagram of a partial structure of a first button module of the mobile phone shown in FIG. 2;

FIG. 8 is a diagram of a split structure of the first button module shown in FIG. 7;

FIG. 9 is a diagram of a structure of a first circuit board in the first button module shown in FIG. 8;

FIG. 10 is a diagram of a structure of a first reinforcing plate in the first button module shown in FIG. 8;

FIG. 11 is a diagram of a partial structure of a second button module of the mobile phone shown in FIG. 2;

FIG. 12 is a diagram of a split structure of the second button module shown in FIG. 11;

FIG. 13 is a diagram of a structure of a second circuit board in the second button module shown in FIG. 12;

FIG. 14 is a diagram of a structure of a third reinforcing plate shown in FIG. 12;

FIG. 15 is a diagram of an assembly state of a partial structure of the mobile phone shown in FIG. 2;

FIG. 16 is a diagram of a structure of the partial structure of the mobile phone shown in FIG. 15 from another viewing angle;

FIG. 17 is a diagram of the assembled partial structure of the mobile phone shown in FIG. 2;

FIG. 18 is an enlarged view of a structure of a region A in FIG. 17;

FIG. 19 is an enlarged view of a structure of a region B in FIG. 17; and

FIG. 20 is a diagram of part of an internal structure of a first housing shown in FIG. 2.

### DETAILED DESCRIPTION OF EMBODIMENTS

The following describes embodiments of this application with reference to the accompanying drawings in embodiments of this application.

An embodiment of this application provides an electronic device. The electronic device includes, but is not limited to, a bar phone, a foldable phone, a notebook computer, a tablet computer, a personal digital assistant, a wearable device, a vehicle-mounted device, or the like. The wearable device may be specifically a wearable watch, a wearable band, or the like.

In this embodiment of this application, an example is used for description, in which the electronic device is a foldable phone.

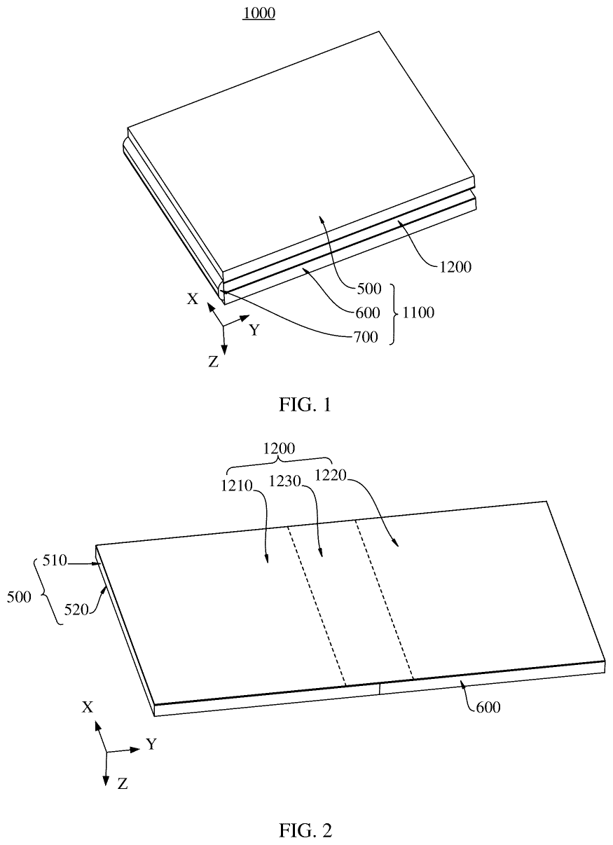

Refer to FIG. 1 and FIG. 2. FIG. 1 is a diagram of a mobile phone 1000 in a first state according to an embodiment of this application. FIG. 2 is a diagram of the mobile phone 1000 in a second state according to the embodiment of this application.

The foldable phone 1000 shown in FIG. 1 is in a folded state. The foldable phone 1000 shown in FIG. 2 is in an unfolded state. An angle by which the foldable phone 1000 shown in FIG. 2 is unfolded is 180 degrees. It should be noted that a slight deviation is allowed for each angle used as an example in this embodiment of this application. For example, that the angle by which the foldable phone 1000 shown in FIG. 2 is unfolded is 180 degrees means that the angle may be 180 degrees, or may be 180±10 degrees. An angle used as an example in the following may be understood in the same way.

For ease of description, a length direction of the foldable phone 1000 is defined as an X-axis direction (a first direction), a width direction of the foldable phone 1000 is defined as a Y-axis direction (a second direction), and a thickness direction of the foldable phone 1000 is defined as a Z-axis direction (a third direction). The X-axis direction, the Y-axis direction, and the Z-axis direction are mutually perpendicular to each other. In another embodiment, the first direction may be the Y-axis direction, and the second direction may be the X-axis direction.

It should be noted that positional words such as “top”, “bottom”, “left”, “right”, “front”, and “back” that are used when the mobile phone 1000 is described in this embodiment of this application are mainly defined based on a position in which the mobile phone 1000 is shown in FIG. 2. A part in a positive direction of a Z-axis is defined as “top” or “upper part”, while a part in a negative direction of the Z-axis is defined as “bottom” or “lower part”, a side in a positive direction of an X-axis is defined as “right”, while a side in a negative direction of the X-axis is defined as “left”, and a part in a positive direction of a Y-axis is defined as “back”, while a part in a negative direction of the Y-axis is defined as “front”, which do not constitute a limitation on a position of the mobile phone 1000 in an actual application scenario.

The foldable phone 1000 includes a main body 1100 and a display 1200. The display 1200 is mounted on the main body 1100. The display 1200 includes a display side and a mounting side, with the display side and the mounting side disposed facing away from each other. The display side is configured to display text, images, videos, and the like. The display 1200 includes a first display part 1210, a second display part 1220, and a third display part 1230. The third display part 1230 is located between the first display part 1210 and the second display part 1220. The third display part 1230 is flexible and may bend in an X-axis direction. Actually, the first display part 1210 and the second display part 1220 may also bend when they are not fastened. A direction in which the display 1200 displays pictures may be parallel to the X-axis direction or the Y-axis direction.

In this embodiment, the display 1200 is a flexible display 1200, for example, an organic light-emitting diode (OLED) display 1200, an active-matrix organic light-emitting diode (AMOLED) display 1200, a mini light-emitting diode display 1200, a micro light-emitting diode display 1200, a micro organic light-emitting diode display 1200, or a quantum dot light-emitting diode (QLED) display 1200.

With reference to FIG. 1 and FIG. 2, the main body 1100 includes housings and a rotating mechanism 700. The housings include a first housing 500 and a second housing 600. The rotating mechanism 700 is connected between the first housing 500 and the second housing 600. When the rotating mechanism 700 rotates, the first housing 500 and the second housing 600 unfold or fold relative to each other.

In this embodiment, the rotating mechanism 700 may be a hinge. The rotating mechanism 700 is connected between the first housing 500 and the second housing 600, equivalent to a rotating structure between the first housing 500 and the second housing 600, to implement that the first housing 500 and the second housing 600 rotate freely and fold relative to each other. Specifically, the rotating mechanism 700 includes two hinges that are connected to each other. The two hinges are arranged sequentially in the Y-axis direction, with one of the hinges connected to the first housing 500 and the other connected to the second housing 600. Alternatively, the rotating mechanism 700 includes one hinge. In the Y-axis direction, the hinge extends from one side of the mobile phone 1000 to the other side. In another embodiment, the rotating mechanism 700 includes two rotating shafts that are connected to each other and can rotate relative to each other. One of the rotating shafts is rotatably connected to the first housing 500, and the other is rotatably connected to the second housing 600, to implement that the first housing 500 and the second housing 600 rotate relative to each other. In another embodiment, the rotating mechanism 700 may alternatively be a rotating structure of another design, provided that the first housing 500 and the second housing 600 can rotate freely and fold relative to each other without damaging the display 1200.

The display 1200 is stacked on the first housing 500, the second housing 600, and the rotating mechanism 700. The first display part 1210 is opposite the first housing 500. The second display part 1220 is opposite the second housing 600. The third display part 1230 is opposite the rotating mechanism 700. When unfolding relative to each other, the first housing 500 and the second housing 600 are distributed side by side in the Y-axis direction. In this case, an angle between the first housing 500 and the second housing 600 is 180 degrees; the display 1200 is in an unfolded state; and the rotating mechanism 700 is housed in the first housing 500 and the second housing 600. When folding relative to each other, the first housing 500 and the second housing 600 are stacked in the Z-axis direction. In this case, an angle between the first housing 500 and the second housing 600 is 0 degrees; the display 1200 is in a folded state; and a part of the rotating mechanism 700 is exposed and located between the first housing 500 and the second housing 600, serving as an exterior part of the mobile phone 1000. Regarding that the angle between the first housing 500 and the second housing 600 is 180 degrees or 0 degrees, a value in an angle tolerance range for assembly is allowed. For example, 180 degrees may be understood as 179 degrees, and 0 degrees may be understood as 1 degree.

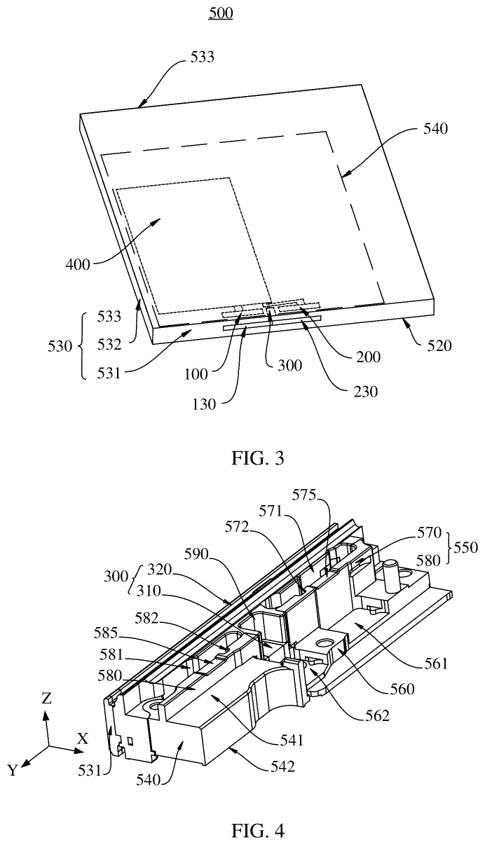

Refer to FIG. 3. FIG. 3 is a diagram of a structure of the first housing 500 of the mobile phone shown in FIG. 2. In this embodiment, the mobile phone 1000 further includes a first button module 100, a second button module 200, an antenna 300, and a device circuit board 400. The first button module 100, the second button module 200, the antenna 300, and the device circuit board 400 are all disposed in the first housing 500 or the second housing 600. An example is used, in which the first button module 100, the second button module 200, the antenna 300, and the device circuit board 400 are all disposed in the first housing 500. The device circuit board 400 may be a main board of the mobile phone 1000. A radio frequency chip (not shown in the figure) and a control chip (not shown in the figure) are integrated on the device circuit board 400. The control chip may be a central processing unit of the mobile phone 1000. The antenna 300 may be an antenna 300 supporting 4G or 5G frequency bands. The antenna 300 is electrically connected to the radio frequency chip, so that the mobile phone 1000 can receive or transmit signals. In this embodiment, the first button module 100 may be a volume increasing module, and the second button module 200 may be a volume decreasing module. The first button module 100 is electrically connected to the control chip. When a user operates the first button module 100, the control chip may control the volume of the mobile phone 1000 to increase after receiving a signal from the first button module 100. The second button module 200 is electrically connected to the control chip. When a user operates the second button module 200, the control chip may control the volume of the mobile phone 1000 to decrease after receiving a signal from the second button module 200.

In another embodiment, the first button module 100 may be a volume decreasing module, and the second button module 200 may be a volume increasing module. Alternatively, the first button module 100 may be a power button module, and the second button module 200 may be a volume decreasing module.

With reference to FIG. 3, in this embodiment, the first housing 500 includes a first backplane 520 and a first middle frame 510. The first backplane 520 is in a shape of a rectangular thin plate. The first middle frame 510 may be made of metal, or may be made of metal and plastic. The first middle frame 510 includes a border frame 530 and a supporting piece 540. The supporting piece 540 is in a shape of a rectangular thin plate. The supporting piece 540 includes a first surface 541 and a second surface 542, with the first surface 541 and the second surface 542 disposed facing away from each other in the Z-axis direction. The border frame 530 is in a shape of a rectangular frame. The border frame 530 surrounds and is fastened on a periphery of the supporting piece 540. A side that is of the border frame 530 and that is located in the negative direction of the Z-axis is flush with the second surface 542 of the supporting piece 540, to facilitate supporting of the display 1200. A side that is of the border frame 530 and that is located in the positive direction of the Z-axis protrudes relative to the first surface 541 of the supporting piece 540, so that the border frame 530 and the supporting piece 540 enclose accommodating space (not marked in the figure). The accommodating space is used to accommodate components such as the first button module 100, the second button module 200, and the device circuit board 400. The first backplane 520 is fastened to the side that is of the border frame 530 and that is located in the positive direction of the Z-axis, to seal the accommodating space.

The border frame 530 includes a first border frame 531, a second border frame 532, and a third border frame 533. The first border frame 531 and the third border frame 533 are opposite each other in the X-axis direction. The first border frame 531 and the third border frame 533 are two long sides of the border frame 530. The second border frame 532 is connected between the first border frame 531 and the third border frame 533. The second border frame 532 is a short side of the border frame 530. A side that is of the border frame 530 and that is opposite the second border frame 532 in the Y-axis direction is used to accommodate the rotating mechanism 700.

Refer to FIG. 4. FIG. 4 is a diagram of a partial structure of the first middle frame shown in FIG. 3. The supporting piece 540 includes a housing portion 550 and an accommodating portion 560. The housing portion 550 is connected to the first border frame 531. The accommodating portion 560 is connected to a side that is of the housing portion 550 and that is away from the first border frame 531. In other words, in the X-axis direction, the first border frame 531, the housing portion 550, and the accommodating portion 560 are arranged sequentially. Specifically, the housing portion 550 includes a first housing portion 570 and a second housing portion 580. In the Y-axis direction, the first housing portion 570 and the second housing portion 580 are spaced apart.

The first housing portion 570 may be bar-shaped. A length direction of the first housing portion 570 is parallel to the Y-axis direction. The first housing portion 570 may be a protrusion of the first surface 541. The first housing portion 570 is provided with a first housing groove 571, a first fixing groove 572, and a first avoidance groove 575. The first housing groove 571 and the first fixing groove 572 are both recessed into a side that is of the first housing portion 570 and that faces away from the first surface 541. The first fixing groove 572 further runs through a groove side of the first housing groove 571. The first avoidance groove 575 is recessed into the side that is of the first housing portion 570 and that faces away from the first surface 541. In addition, the first avoidance groove 575 runs through the groove side of the first housing groove 571 and a side that is of the first housing portion 570 and that faces away from the first border frame 531. The first housing groove 571 is provided for mounting some components of the first button module 100. The first fixing groove 572 is provided to fix the first button module 100 in place. The first avoidance groove 575 is provided to avoid some components of a first button 110 assembly.

The second housing portion 580 may be bar-shaped. A length direction of the second housing portion 580 is parallel to the Y-axis direction. The second housing portion 580 may be a protrusion of the first surface 541. The second housing portion 580 is provided with a second housing groove 581, a third fixing groove 582, and a second avoidance groove 585. The second housing groove 581 and the third fixing groove 582 are both recessed into a side that is of the second housing portion 580 and that faces away from the first surface 541. In addition, a depth and a length of the second housing groove 581 are greater than a depth and a length of the third fixing groove 582, respectively. The third fixing groove 582 further runs through a groove side of the second housing groove 581. The second avoidance groove 585 is recessed into the side that is of the second housing portion 580 and that faces away from the first surface 541. In addition, the second avoidance groove 585 runs through the groove side of the second housing groove 581 and a side that is of the second housing portion 580 and that faces away from the first border frame 531. The second housing groove 581 is provided for mounting some components of the second button module 200. The third fixing groove 582 is provided to fix the second button module 200 in place. The second avoidance groove 585 is provided to avoid some components of a first button 110 assembly.

With reference to FIG. 4, in the Y-axis direction, a connective portion 590 is provided between the first housing portion 570 and the second housing portion 580. The connective portion 590 protrudes from the first surface 541. In the X-axis direction, the connective portion 590 is connected to the first border frame 531, and a width of the connective portion 590 is less than both a width of the first housing portion 570 and a width of the second housing portion 580. In other words, the first housing portion 570, the connective portion 590, and the second housing portion 580 enclose U-shaped space. Thicknesses of the first housing portion 570, the second housing portion 580, and the connective portion 590 are basically the same, to facilitate the first housing portion 570 in supporting a sealing piece. Specifically, a surface that is of the connective portion 590 and that faces away from the first surface 541, a surface that is of the first housing portion 570 and that faces away from the first surface 541, and a surface that is of the second housing portion 580 and that faces away from the first surface 541 are connected sequentially and are flush with each other in the Y-axis direction, to form a sealing surface. The sealing surface is provided for disposing the sealing piece (not shown in the figure). It may be understood that the sealing piece is stuck between the sealing surface and the first backplane 520 by using adhesive, to seal a gap between the sealing surface and the first backplane 520, preventing foreign objects such as dust and moisture from entering an accommodating cavity. In this embodiment, the sealing piece may be foam.

The accommodating portion 560 is a portion that is of the supporting piece 540 and that is located on a right side of the housing portion 550. The accommodating portion 560 is provided with the accommodating cavity (not marked in the figure). The accommodating cavity is provided for mounting the device circuit board 400. A cavity bottom of the accommodating cavity is provided with a first accommodating groove 561 and a second accommodating groove 562. The first accommodating groove 561 is located on a right side of the first housing portion 570. The second accommodating groove 562 is located on a right side of the second housing portion 580. The first accommodating groove 561 is provided for mounting some components of the first button module 100. The second accommodating groove 562 is provided for mounting some components of the second button module 200.

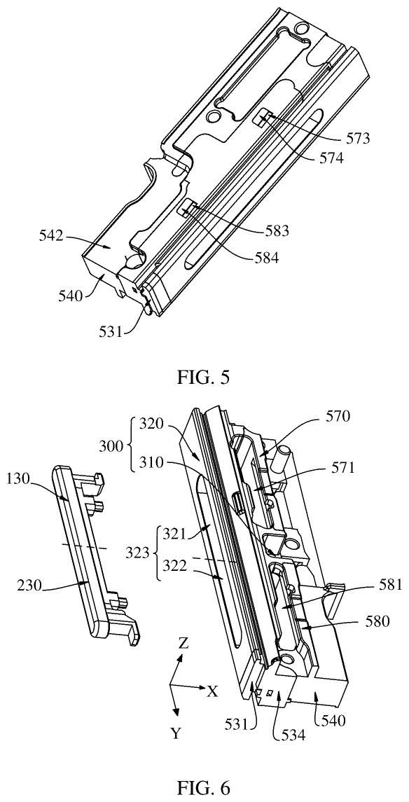

Refer to FIG. 4 and FIG. 5. FIG. 5 is a diagram of the partial structure of the first middle frame shown in FIG. 3 from another viewing angle.

In this embodiment, the first housing portion 570 is further provided with a first fixing hole 573 and a second fixing groove 574. The first fixing hole 573 runs through the second surface 542 and a groove bottom of the first housing groove 571. The second fixing groove 574 is recessed into a hole wall of the first fixing hole 573 and runs through the second surface 542. The first fixing hole 573 and the second fixing groove 574 are provided to fix the first button module 100 in place.

The second housing portion 580 is further provided with a second fixing hole 583 and a fourth fixing groove 584. The second fixing hole 583 runs through the second surface 542 and a groove bottom of the second housing groove 581. The fourth fixing groove 584 is recessed into a hole wall of the second fixing hole 583 and runs through the second surface 542. The second fixing hole 583 and the fourth fixing groove 584 are provided to fix the second button module 200 in place.

It may be understood that each of the first housing groove 571, the first fixing groove 572, the first fixing hole 573, the second fixing groove 574, the first avoidance groove 575, the second housing groove 581, the third fixing groove 582, the second fixing hole 583, the fourth fixing groove 584, the second avoidance groove 585, the accommodating cavity, the first accommodating groove 561, the second accommodating groove 562, and the like is a part of the accommodating space.

FIG. 6 is a diagram of a partial structure of the mobile phone 1000 shown in FIG. 2. In this embodiment, the antenna 300 includes a feeding portion 310, a radiator 320, and a spring (not shown in the figure). The feeding portion 310 may be a part of the supporting piece 540, that is, a part of the supporting piece 540 forms the feeding portion 310. In other words, the feeding portion 310 is integrally formed with the first housing 500. More specifically, the feeding portion 310 may be integrally formed with the supporting piece 540. Therefore, there is no need to dispose an additional component as the feeding portion 310, reducing a quantity of components in the mobile phone 1000, avoiding a step of fitting the feeding portion 310, simplifying assembly steps, and increasing assembly efficiency. Specifically, the feeding portion 310 may be a portion that is of the supporting piece 540 and that is located between the first housing portion 570 and the second housing portion 580. In addition, the feeding portion 310 is lower than the first housing portion 570 and the second housing portion 580. The thickness of the first housing portion 570 and the thickness of the second housing portion 580 are both greater than a thickness of the feeding portion 310. Specifically, in other words, the first housing portion 570, the feeding portion 310, and the second housing portion 580 are arranged sequentially in the Y-axis direction. In addition, the feeding portion 310 is located in the U-shaped space enclosed by the first housing portion 570, the connective portion 590, and the second housing portion 580.

In this embodiment, a surface that is of the feeding portion 310 and that faces away from the first surface 541 is basically flush with a surface of the device circuit board 400, to facilitate connection between the feeding portion 310 and the device circuit board 400. Same herein includes a machining error.

The radiator 320 may be a part of the border frame 530, that is, a part of the border frame 530 forms the radiator 320. In other words, the radiator 320 is integrally formed with the first housing 500. More specifically, the radiator 320 may be integrally formed with the border frame 530. When a part of the border frame 530 is used as the radiator 320, there is no need to dispose an additional component as the radiator 320, reducing the quantity of components in the mobile phone 1000, avoiding a step of fitting the radiator 320, simplifying assembly steps, and increasing assembly efficiency. It may be understood that at least a part of the connective portion 590 may be conductive metal, and at least a part of the connective portion 590 is used as the radiator 320, so that the feeding portion 310 can be connected to the radiator 320. It may be understood that portions that are of the first middle frame 510 and that are used as the feeding portion 310 and the radiator 320 are both made of conductive metal. Remaining portions of the first middle frame 510 may be made of an insulating material such as plastic, or may be made of metal.

The radiator 320 may be formed by a part of the border frame 530. Specifically, the radiator 320 may be formed by a part of the first border frame 531. The part that is of the first border frame 531 and that serves as the radiator 320 is made of conductive metal, while the other part of the first border frame 531 is an insulating part 534 (shown in FIG. 6). The insulating part 534 is located between the supporting piece 540 and the radiator 320. A length of the radiator 320 in the Y-axis direction may be designed based on frequency bands that the antenna 300 needs to support. In an embodiment, the radiator 320 needs to radiate signals in intermediate-frequency and high-frequency bands, with the intermediate-frequency and high-frequency bands in a range of 1000 MHz to 3000 MHz. The length of the radiator is approximately ¼ of a wavelength of a signal radiated by the radiator. This is not limited in this embodiment. A thickness of the first border frame 531 in the Z-axis direction is roughly the same as an overall thickness of the mobile phone 1000. When a part of the first border frame 531 is used as the radiator 320, a thickness of the radiator 320 may be roughly the same as the overall thickness of the mobile phone 1000. Therefore, when the antenna 300 supports same frequency bands, the length of the radiator 320 is basically fixed. In this case, if the radiator 320 is thick, a volume of the radiator 320 is large. When the volume of the radiator 320 is large, the antenna 300 can have stronger radiation capabilities.

In addition, the radiator 320 may be formed by the border frame 530. Because the border frame 530 serves as an exterior part of the mobile phone 1000, at least a part of the radiator 320 forms an exterior portion of the mobile phone 1000, that is, the radiator 320 may form a part of an exterior surface of the mobile phone 1000. In this case, at least a part of the radiator 320 is visible. Therefore, this can not only avoid the radiator 320 occupying internal space of the mobile phone 1000, but also avoid another component in the mobile phone 1000 blocking the radiator 320. As such, the antenna 300 has a stronger radiation intensity.

In this embodiment, the radiator 320 is provided with a first through-hole 321 and a second through-hole 322. In the X-axis direction, the first through-hole 321 and the second through-hole 322 both run through the radiator 320. The first through-hole 321 communicates with the first housing groove 571. The second through-hole 322 communicates with the second housing groove 581. The first button module 100 includes a first button cap 130. The second button module 200 includes a second button cap 230. The first through-hole 321 is provided for mounting the first button cap 130. A part of the first button cap 130 extends into the first housing groove 571, so that the first button cap 130 can be connected to other components located in the first housing groove 571. The second through-hole 322 is provided for mounting the second button cap 230. The first button cap 130 and the second button cap 230 may both be made of metal. Therefore, the first button cap 130 and the second button cap 230 provide a good operating feel. Outer surfaces of the first button cap 130 and the second button cap 230 are both provided with an insulating layer (not shown in the figure), so that the first button cap 130 and the second button cap 230 are insulated from each other, further preventing the first button cap 130 and the second button cap 230 from compromising radiation performance of the radiator 320. In another embodiment, the first button cap 130 and the second button cap 230 may be alternatively made of plastic.

In this embodiment, the first button cap 130 and the second button cap 230 are integrally formed. The first through-hole 321 and the second through-hole 322 communicate in the Y-axis direction to form a communicating hole 323. In this way, machining is easy, and the first button cap 130 and the second button cap 230 can be easily mounted into the communicating hole 323 together, increasing assembly efficiency. In addition, there is a strong aesthetic appeal. Certainly, in another embodiment, the first button cap 130 and the second button cap 230 may be separately formed, alternatively, that is, the first button cap 130 and the second button cap 230 are two separate components. The first through-hole 321 and the second through-hole 322 may also be two separate holes.

In this embodiment, a length of the communicating hole 323 in the Y-axis direction is between 15 millimeters and 25 millimeters. The length of the communicating hole 323 may be specifically 15 millimeters, 18 millimeters, 21 millimeters, 24 millimeters, 25 millimeters, or the like. A width of the communicating hole 323 in the Z-axis direction is between 1.2 millimeters and 1.8 millimeters. The width of the communicating hole 323 may be specifically 1.2 millimeters, 1.4 millimeters, 1.6 millimeters, 1.8 millimeters, or the like. If the length or width of the communicating hole 323 is excessively small, accordingly, for a purpose of enabling the first button cap 130 and the second button cap 230 to be smoothly mounted into the communicating hole 323, volumes of the first button cap 130 and the second button cap 230 need to be reduced. However, if the volumes of the first button cap 130 and the second button cap 230 are excessively small, it makes it difficult for a user to operate. If the length or width of the communicating hole 323 is excessively large, the volume of the radiator 320 may be small, resulting in a decrease in radiation performance of the radiator 320. When the length of the communicating hole 323 is set to be between 15 millimeters and 25 millimeters and the width of the communicating hole 323 is set to be between 1.2 millimeters and 1.8 millimeters, not only the communicating hole 323 can accommodate the first button cap 130 and the second button cap 230 that are easy for a user to operate, but also impact of the communicating hole 323 on radiation performance of the radiator can be reduced.

In a related technology, as a mobile phone 1000 needs to support an increasing quantity of frequency bands, a corresponding quantity of antennas 300 is increasing, and space required for disposing the antennas 300 is also growing. However, an increase in the quantity of antennas 300 goes against a trend of making the mobile phone 1000 thinner and lighter. For a purpose of meeting a requirement for the quantity of antennas 300, portions that are of a border frame 530 of the mobile phone 1000 and at which no other components are disposed are also used as radiators 320 of the antennas 300. Correspondingly, feeding portions 310 connected to the antennas 300 are disposed in spare positions on a supporting piece 540. However, the quantity of antennas 300 still cannot meet the requirement.

In this embodiment, for a purpose of resolving the foregoing problem, regions that are of the border frame 530 and that are used for mounting the first button cap 130 and the second button cap 230 are also utilized. More specifically, regions that are of the first border frame 531 and in which the first button cap 130 and the second button cap 230 are disposed are utilized for disposing the radiator 320, and regions that are of the supporting piece 540 and in which the first button module 100 and the second button module 200 are mounted are utilized for disposing the feeding portion 310. In this way, the radiators 320 can be electrically connected to the radio frequency chip on the device circuit board 400 through the feeding portions 310, implementing functions of the antennas 300. As such, not only a quantity of the antennas 300 can be increased, but also the antennas 300 can be prevented from compromising a design of making the mobile phone 1000 thinner and lighter.

In this embodiment, one end of the spring is connected to the radio frequency chip, and the other end is connected to the feeding portion 310. The feeding portion 310 is then connected to the radiator 320. In this way, a signal transmitted by the radio frequency chip may be transmitted to the radiator 320 after passing through the spring and the feeding portion 310 sequentially. The radiator 320 then radiates the signal. Alternatively, after receiving the signal transmitted by the spring, the feeding portion 310 may directly radiate the signal. A signal received by the radiator 320 may also be transmitted to the radio frequency chip after passing through the feeding portion 310 and the spring sequentially. In addition to receiving a signal transmitted by the radiator 320, the feeding portion 310 itself may directly receive an external signal. A signal directly received by the feeding portion 310 may also be transmitted to the radio frequency chip through the spring, to implement a communication function of the mobile phone 1000.

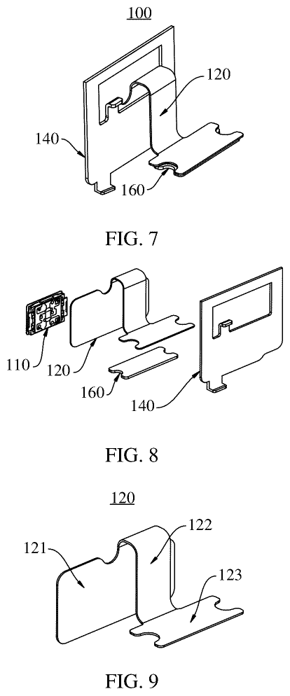

Refer to FIG. 7 and FIG. 8. FIG. 7 is a diagram of a partial structure of the first button module 100 of the mobile phone 1000 shown in FIG. 2. FIG. 8 is a diagram of a split structure of the first button module 100 shown in FIG. 7.

In this embodiment, the first button module 100 includes a first button 110, a first circuit board 120, the first button cap 130 (shown in FIG. 3), a first reinforcing plate 140, and a second reinforcing plate 160. The first circuit board 120 may be a flexible circuit board. In another embodiment, the first circuit board 120 may alternatively be a component such as a rigid circuit board or an electrically conductive piece.

In the X-axis direction, the first button cap 130, the first button 110, and the first circuit board 120 are connected sequentially. A side that is of the first circuit board 120 and that is away from the first button 110 is connected to the control chip of the device circuit board 400. In other words, in the X-axis direction (the first direction), two sides of the first circuit board 120 are connected to the first button 110 and the device circuit board 400, respectively. In another embodiment, the first direction may alternatively be the Y-axis direction. When a user presses the first button cap 130, pressure acts on the first button 110 through the first button cap 130. A signal change generated by the first button 110 is transmitted to the control chip through the first circuit board 120. After receiving the signal, the control chip controls the volume of the mobile phone 1000 to increase. The first reinforcing plate 140 is connected to a part at which the first circuit board 120 and the first button 110 are connected, to support the part at which the first circuit board 120 and the first button 110 are connected, and to enhance structural strength of the part. The second reinforcing plate 160 is connected to a part at which the first circuit board 120 and the device circuit board 400 are connected, to enhance structural strength of the part.

Refer to FIG. 9. FIG. 9 is a diagram of a structure of the first circuit board 120 in the first button module 100 shown in FIG. 8.

In this embodiment, the first circuit board 120 includes a first connecting portion 121, a first flexible portion 122, and a second connecting portion 123 that are connected sequentially in the X-axis direction. The first connecting portion 121 is configured to be connected to the first button 110. The first flexible portion 122 is connected to the first connecting portion 121 and the second connecting portion 123. The second connecting portion 123 is configured to be connected to the device circuit board 400. A width of the first flexible portion 122 is less than both a width of the first connecting portion 121 and a width of the second connecting portion 123. In this way, the first connecting portion 121 can be reliably connected to the first button 110, the second connecting portion 123 can be reliably connected to the device circuit board 400, and the first flexible portion 122 can be reliably connected to both the first connecting portion 121 and the second connecting portion 123. In addition, an area of the first flexible portion 122 is small, reducing space occupied by the first circuit board 120, and decreasing material consumption.

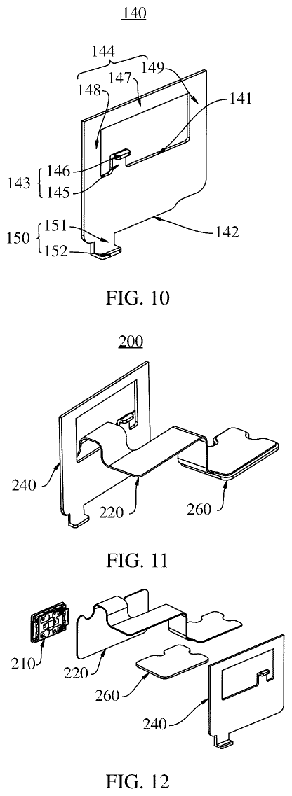

Refer to FIG. 10. FIG. 10 is a diagram of a structure of the first reinforcing plate 140 in the first button module 100 shown in FIG. 8.

In this embodiment, the first reinforcing plate 140 includes a first long side 141 and a second long side 142. A first fixing protrusion 143 and a first handle protrusion 144 protrude from the first long side 141. The first fixing protrusion 143 includes a first extension portion 145 and a first fixing portion 146. One end of the first extension portion 145 is fastened to the first long side 141. The first fixing portion 146 is fastened to the other end of the first extension portion 145. The first fixing portion 146 and the first extension portion 145 are perpendicular to each other. In other words, the first extension portion 145 and the first fixing portion 146 are connected in a shape of L. The end that is of the first extension portion 145 and that is away from the first fixing portion 146 is fastened to the first long side 141. The first fixing portion 146 is configured to fit with the first housing portion 570, to restrict the first reinforcing plate 140 from shifting in the Y-axis direction.

In another embodiment, the first extension portion 145 and the first fixing portion 146 may alternatively not be perpendicular to each other. For example, an angle between the first extension portion 145 and the first fixing portion 146 may be 70 degrees, 80 degrees, or the like.

In this embodiment, the first handle protrusion 144 is configured to help the first button module 100 be easily fitted into the first housing portion 570. The first handle protrusion 144 includes a first handle portion 147, a first connecting leg 148, and a second connecting leg 149. The first handle portion 147 may be in a shape of a rectangular sheet. The first connecting leg 148 and the second connecting leg 149 are both connected to a long side of the first handle portion 147, and spaced apart. An end that is of the first connecting leg 148 and that is away from the first handle portion 147 and an end that is of the second connecting leg 149 and that is away from the first handle portion 147 are both fastened to the first long side 141. The first fixing protrusion 143 is located between the first connecting leg 148 and the second connecting leg 149. In this way, when a length of the first long side 141 is limited, space on the first long side 141 is fully utilized for disposing the first handle protrusion 144 and the first fixing protrusion 143. As such, the first button module 100 can be both fixed in place in the Y-axis direction and easily fitted. In another embodiment, the first handle protrusion 144 may alternatively be in another shape, for example, a shape of a semi-ring. The shape is not limited in this application, provided that the first handle protrusion 144 can be easy to hold and can avoid the first fixing protrusion 143.

It may be understood that a position, illustrated in FIG. 10, in which the first fixing protrusion 143 is between the first connecting leg 148 and the second connecting leg 149 is merely an example. Actually, the first fixing protrusion 143 may be alternatively connected to another position on the first long side 141.

A second fixing protrusion 150 protrudes from the second long side 142. The second fixing protrusion 150 includes a second extension portion 151 and a second fixing portion 152. One end of the second extension portion 151 is fastened to the second long side 142. The second fixing portion 152 is fastened to the other end of the second extension portion 151. The second fixing portion 152 and the second extension portion 151 are perpendicular to each other. In other words, the second extension portion 151 and the second fixing portion 152 are connected in the shape of L. The end that is of the second extension portion 151 and that is away from the second fixing portion 152 is fastened to the second long side 142. The second fixing portion 152 is configured to fit with the first housing portion 570, to restrict the first reinforcing plate 140 from shifting in the Z-axis direction. In this embodiment, there is one second fixing protrusion 150. In another embodiment, there may alternatively be two second fixing protrusions 150, three second fixing protrusions 150, or the like. The second extension portion 151 and the second fixing portion 152 may alternatively not be perpendicular to each other. For example, an angle between the second extension portion 151 and the second fixing portion 152 may be 73 degrees, 87 degrees, or the like. It may be understood that a position, illustrated in FIG. 10, at which the second fixing protrusion 150 is connected to the second long side 142 is merely an example. Actually, the second fixing protrusion 150 may be alternatively connected to another position on the second long side 142.

In this embodiment, the first button 110, the first connecting portion 121 of the first circuit board 120, and the first reinforcing plate 140 are stacked sequentially. The first button 110 and the first connecting portion 121 are fastened together, implementing electrical connection between the first button 110 and the first connecting portion 121. The first connecting portion 121 and the first reinforcing plate 140 are stuck together by using adhesive. The second connecting portion 123 of the first circuit board 120 and the second reinforcing plate 160 are stacked. The second connecting portion 123 and the second reinforcing plate 160 are stuck together by using adhesive. The first reinforcing plate 140 supports and reinforces the first connecting portion 121 and the first button 110. In this case, the first connecting portion 121 does not deform. The second reinforcing plate 160 supports and reinforces the second connecting portion 123. In this case, the second connecting portion 123 does not deform. The first flexible portion 122 may deform, so that the first connecting portion 121 and the second connecting portion 123 can be in a state of being perpendicular to each other, to help the first button module 100 be fitted into the first housing 500. The first flexible portion 122 of the first circuit board 120 is located between the second connecting leg 149 and the first fixing protrusion 143. In other words, the first connecting leg 148, the first flexible portion 122, the first fixing protrusion 143, and the second connecting leg 149 are arranged sequentially. In this way, in limited space on the first long side 141, the first connecting leg 148, the first flexible portion 122, the first fixing protrusion 143, and the second connecting leg 149 do not interfere with each other, increasing structural stability of the first button module 100. The first fixing protrusion 143 and the second fixing protrusion 150 are located on two opposite sides of the first reinforcing plate 140, fully utilizing space on the first reinforcing plate 140.

Refer to FIG. 11 and FIG. 12. FIG. 11 is a diagram of a partial structure of the second button module 200 of the mobile phone 1000 shown in FIG. 2. FIG. 12 is a diagram of a split structure of the second button module 200 shown in FIG. 11.

The second button module 200 includes a second button 210, a second circuit board 220, the second button cap 230 (shown in FIG. 3), a third reinforcing plate 240, and a fourth reinforcing plate 260. The structure of the second button module 200 is similar to that of the first button module. For structures of and connections between the components included in the second button module 200, refer to the related descriptions of the first button module. Details are not described herein again. The second button module 200 differs from the first button module in that the second button module 200 may be configured to control the volume of the mobile phone to decrease. The second button module 200 further differs from the first button module in that a specific shape of the second circuit board 220 is different.

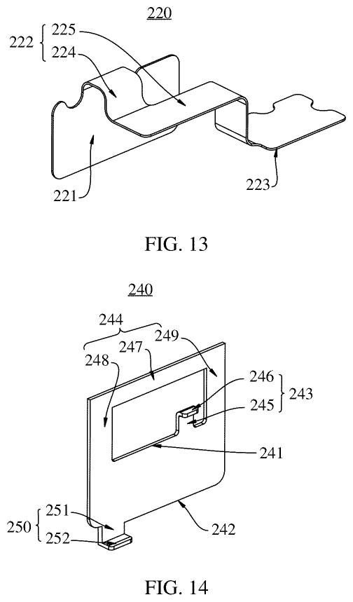

Refer to FIG. 13. FIG. 13 is a diagram of a structure of the second circuit board 220 in the second button module 200 shown in FIG. 12.

In this embodiment, the second circuit board 220 includes a third connecting portion 221, a second flexible portion 222, and a fourth connecting portion 223 that are connected sequentially in the X-axis direction. The third connecting portion 221 is configured to be connected to the second button 210. The second flexible portion 222 is configured to be connected to the third connecting portion 221 and the fourth connecting portion 223. The fourth connecting portion 223 is configured to be connected to the device circuit board 400. A width of the second flexible portion 222 is less than both a width of the third connecting portion 221 and a width of the fourth connecting portion 223. The second flexible portion 222 is disposed in the shape of L, so that the second button 210 can be electrically connected through the second circuit board 220. Specifically, the second flexible portion 222 includes a first flexible segment 224 and a second flexible segment 225. The first flexible segment 224 and the second flexible segment 225 are connected in the shape of L. The first flexible segment 224 extends in the X-axis direction. An end that is of the first flexible segment 224 and that is away from the second flexible segment 225 is connected to the third connecting portion 221. The second flexible segment 225 extends in the Y-axis direction. An end that is of the second flexible segment 225 and that is away from the first flexible segment 224 is connected to the fourth connecting portion 223. In this way, the third connecting portion 221 can be reliably connected to the second button 210, the fourth connecting portion 223 can be reliably connected to the device circuit board 400, and the second flexible portion 222 can be reliably connected to both the third connecting portion 221 and the fourth connecting portion 223. In addition, an area of the second flexible portion 222 is small, reducing space occupied by the second circuit board 220, and decreasing material consumption. In another embodiment, the third connecting portion 221, the second flexible portion 222, and the fourth connecting portion 223 may alternatively be in other shapes.

Refer to FIG. 14. FIG. 14 is a diagram of a structure of the third reinforcing plate 240 shown in FIG. 12.

The third reinforcing plate 240 includes a third long side 241 and a fourth long side 242. A third fixing protrusion 243 and a second handle protrusion 244 protrude from the third long side 241. The second handle protrusion 244 includes a second handle portion 247, a third connecting leg 248, and a fourth connecting leg 249. The third fixing protrusion 243 includes a third extension portion 245 and a third fixing portion 246. A fourth fixing protrusion 250 protrudes from the fourth long side 242. The fourth fixing protrusion 250 includes a fourth extension portion 251 and a fourth fixing portion 252. For structures of, connections between, and functions of the components of the third reinforcing plate 240, refer to the related descriptions of the first reinforcing plate.

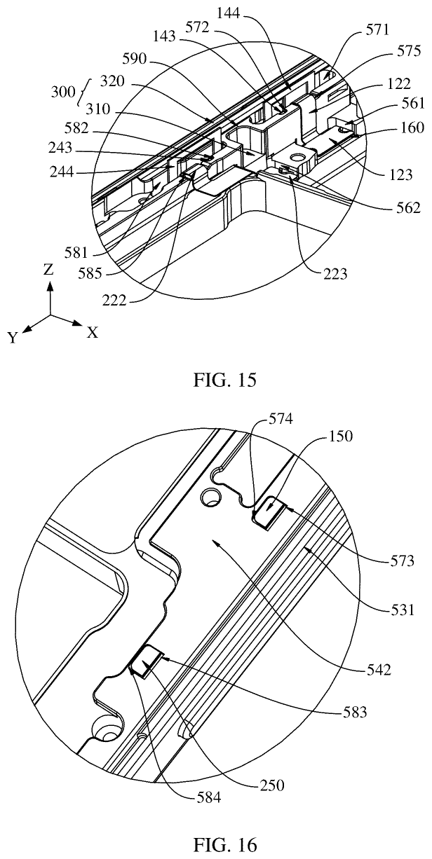

Refer to FIG. 15. FIG. 15 is a diagram of an assembly state of a partial structure of the mobile phone 1000 shown in FIG. 2. Neither the first handle protrusion 144 of the first reinforcing plate 140 nor the second handle protrusion 244 of the third reinforcing plate 240 shown in FIG. 15 is broken off.

During assembly of the mobile phone 1000, an operator holds the first handle protrusion 144, and mounts the first reinforcing plate 140 into the first housing groove 571 from an opening of the first housing groove 571. Because the first button 110 and the first connecting portion 121 are both fastened to the first reinforcing plate 140, the first button 110 and the first connecting portion 121 are also mounted into the first housing groove 571 together with the first reinforcing plate 140. During mounting, a side that is of the first button 110 and that faces away from the first connecting portion 121 presses against the first button cap 130, and a side that is of the first reinforcing plate 140 and that faces away from the first connecting portion 121 is stuck onto the groove side of the first housing groove 571 by using adhesive. In other words, the first button cap 130, the first button 110, the first connecting portion 121, and the first reinforcing plate 140 are stacked sequentially and fastened together in the X-axis direction.

The first long side 141 of the first reinforcing plate 140 is located at the opening of the first housing groove 571. The first fixing portion 146 of the first fixing protrusion 143 extends into the first fixing groove 572 and presses against a groove bottom of the first fixing groove 572, to restrict the first reinforcing plate 140 from moving in the Y-axis direction, that is, to restrict the first button 110 and the first connecting portion 121 from moving in the Y-axis direction. Further, this can avoid the first button 110 and the first button cap 130 being misaligned in the Y-axis direction, increase precision of positions of the first button 110 and the first button cap 130 in the Y-axis direction, and improve smoothness that corresponds to a case in which the first button cap 130 is pressed.

Refer to FIG. 16. FIG. 16 is a diagram of a structure of the partial structure of the mobile phone 1000 shown in FIG. 15 from another viewing angle.

The second extension portion 151 of the second fixing protrusion 150 extends into the first fixing hole 573, and the second fixing portion 152 of the second fixing protrusion 150 extends into the second fixing groove 574 and presses against a groove bottom of the second fixing groove 574, to restrict the first reinforcing plate 140 from moving in the Z-axis direction, that is, to restrict the first button 110 and the first connecting portion 121 from moving in the Z-axis direction. Further, this can avoid the first button 110 and the first button cap 130 being misaligned in the Z-axis direction, increase precision of positions of the first button 110 and the first button cap 130 in the Z-axis direction, and improve smoothness that corresponds to a case in which the first button cap 130 is pressed.

At least a part of the first handle protrusion 144 is located outside the first housing groove 571. Then, the operator may break off the first handle protrusion 144 from the first reinforcing plate 140, so that the first handle protrusion 144 is separated from the first reinforcing plate 140.

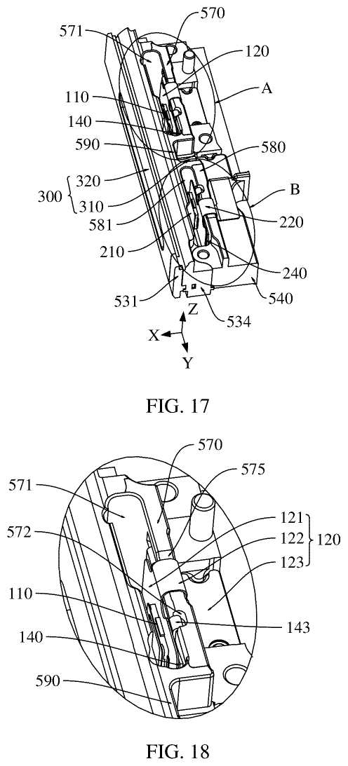

Refer to FIG. 17 and FIG. 18. FIG. 17 is a diagram of the assembled partial structure of the mobile phone 1000 shown in FIG. 2. FIG. 18 is an enlarged view of a structure of a region A in FIG. 17. The first handle protrusion 144 of the first reinforcing plate 140 shown in FIG. 17 and FIG. 18 has been broken off. In this way, during mounting, the first handle protrusion 144 may be held by the operator, and after the mounting is completed, the first handle protrusion 144 is broken off, preventing the first handle protrusion 144 from occupying space and affecting fitting of other components.

Then, the operator may hold the second reinforcing plate 160 and the second connecting portion 123 and mount the second reinforcing plate 160 and the second connecting portion 123 into the first accommodating groove 561, with the second connecting portion 123 perpendicular to the first connecting portion 121. The second connecting portion 123 and the second reinforcing plate 160 are stacked and fastened together in the Z-axis direction. Then, a surface that is of the second reinforcing plate 160 and that faces away from the second connecting portion 123 may be stuck onto a groove bottom of the first accommodating groove 561 by using adhesive. The second reinforcing plate 160 and the second connecting portion 123 are disposed in the first accommodating groove 561, fully utilizing space inside the housing, and preventing the second reinforcing plate 160 and the second connecting portion 123 from protruding and pressing against the device circuit board 400. As such, stability of the device circuit board 400 can be increased, and the second connecting portion 123 can be smoothly connected to the device circuit board 400.

The second connecting portion 123 and the first connecting portion 121 being perpendicular to each other may be implemented through deformation of the first flexible portion 122. Specifically, a first part of the first flexible portion 122 enters the first avoidance groove 575 after bending 90 degrees relative to the first connecting portion 121; a second part of the first flexible portion 122 is stacked, after bending 90 degrees relative to the first part of the first flexible portion 122, on the side that is of the first housing portion 570 and that faces away from the first border frame 531; and the second part of the first flexible portion 122 is parallel to the first connecting portion 121. In this case, the second connecting portion 123 and the first connecting portion 121 are perpendicular to each other.

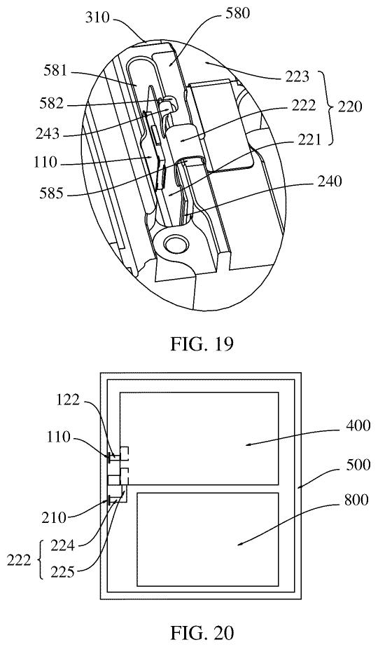

Refer to FIG. 17 and FIG. 19. FIG. 19 is an enlarged view of a structure of a region B in FIG. 17. FIG. 17 and FIG. 19 show a state in which the second button module 200 is mounted. For a process of mounting the second button module 200, refer to the process of mounting the first button module 100, and details are not described in this embodiment again.

After the first button module 100 and the second button module 200 are both mounted, the device circuit board 400 may be mounted into the accommodating cavity, the second connecting portion 123 may be connected to the control chip by a board-to-board connector, and the fourth connecting portion 223 may also be connected to the control chip by a board-to-board connector. The feeding portion 310 is connected to the radio frequency chip by the spring.

After the first button module 100 and the second button module 200 are mounted, in the Y-axis direction (the second direction), the first circuit board 120 and the feeding portion 310 are spaced apart, and the second circuit board 220 and the feeding portion 310 are also spaced apart, further avoiding the first circuit board 120 and the second circuit board 220 affecting a signal radiation intensity of the feeding portion 310. In the X-axis direction, the first circuit board 120 and the radiator 320 are spaced apart, and the second circuit board 220 and the radiator 320 are also spaced apart, further avoiding the first circuit board 120 and the second circuit board 220 affecting a signal radiation intensity of the radiator 320. The first circuit board 120 and the radiator 320 may be separated by the insulating part 534 and the first housing portion 570. Likewise, the second circuit board 220 and the radiator 320 may be separated by the insulating part 534 and the second housing portion 580.

Further, in the Y-axis direction, a distance between the first circuit board 120 and the feeding portion 310 is at least 0.8 millimeter. The distance between the first circuit board 120 and the feeding portion 310 may be specifically 0.8 millimeter, 1 millimeter, 1.2 millimeters, or the like. A distance between the second circuit board 220 and the feeding portion 310 is at least 0.8 millimeter. The distance between the second circuit board 220 and the feeding portion 310 may be specifically 0.8 millimeter, 0.9 millimeter, 1.1 millimeters, or the like. Therefore, there is adequate clearance between the first circuit board 120 and the feeding portion 310, and there is also adequate clearance between the second circuit board 220 and the feeding portion 310. As such, radiation performance of the feeding portion 310 can be better leveraged.

A distance between the first circuit board 120 and the radiator 320 is at least 0.8 millimeter. Specifically, the distance may be 0.8 millimeter, 1 millimeter, 1.3 millimeters, 1.5 millimeters, or the like. A distance between the second circuit board 220 and the radiator 320 is at least 0.8 millimeter. Specifically, the distance may be 0.8 millimeter, 0.9 millimeter, 1.1 millimeters, 1.3 millimeters, or the like. Therefore, there is adequate clearance between the first circuit board 120 and the radiator 320, and there is also adequate clearance between the second circuit board 220 and the radiator 320. As such, radiation performance of the radiator 320 can be better leveraged.

In addition, in this embodiment, the first circuit board 120 is used to connect the first button 110 and the radio frequency chip of the device circuit board 400. A thickness of the first circuit board 120 is between 0.08 millimeter and 0.15 millimeter. With the first circuit board 120 being thin, a volume of the first button module 100 can be reduced, to save internal space of the first housing 500. In addition, because the first flexible portion 122 can deform, relative positions of the radio frequency chip and the first button 110 can be flexible, that is, electrical connection between the radio frequency chip and the first button 110 can be implemented through deformation of the first flexible portion 122, regardless of how the relative positions of the radio frequency chip and the first button 110 change. Furthermore, because the first flexible portion 122 can deform, the first flexible portion 122 can press against a corresponding portion of the first housing 500, reducing space occupied by the first flexible portion 122, increasing structural compactness of the assembled first button module 100, and further saving the internal space of the first housing 500.

Likewise, the second circuit board 220 is used to connect the second button 210 and the radio frequency chip of the device circuit board 400. A thickness of the second circuit board 220 is between 0.08 millimeter and 1.5 millimeter. With the second circuit board 220 being thin, a volume of the second button module 200 can be reduced, to save the internal space of the first housing 500. In addition, because the second flexible portion 222 can deform, relative positions of the radio frequency chip and the second button 210 can be flexible, that is, electrical connection between the radio frequency chip and the second button 210 can be implemented through deformation of the second flexible portion 222, regardless of how the relative positions of the radio frequency chip and the second button 210 change. Furthermore, because the second flexible portion 222 can deform, the second flexible portion 222 can press against a corresponding portion of the first housing 500, reducing space occupied by the second flexible portion 222, increasing structural compactness of the assembled second button module 200, and further saving the internal space of the first housing 500.

Refer to FIG. 20. FIG. 20 is a diagram of part of an internal structure of the first housing shown in FIG. 2.

The device circuit board 400 and a battery 800 are arranged in the Y-axis direction. The battery 800 is configured to supply power to components such as the device circuit board 400. The first button 110 is located on a left side of the device circuit board 400. Therefore, the first flexible portion 122 is disposed to extend in the X-axis direction, so that the first button 110 is electrically connected to the device circuit board 400 through the first circuit board 120. The second button 210 is located on a left side of the battery 800. Therefore, the second flexible portion 222 is disposed in the shape of L. Specifically, the second flexible portion 222 includes the first flexible segment 224 and the second flexible segment 225. The first flexible segment 224 and the second flexible segment 225 are connected in the shape of L. The first flexible segment 224 extends in the X-axis direction, and the second flexible segment 225 extends in the Y-axis direction, so that the second circuit board 220 avoids the battery 800 and connects to the device circuit board 400, and the second button 210 is electrically connected to the device circuit board 400 through the second circuit board 220.

The foregoing descriptions are merely some of embodiments and implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. An electronic device, comprising:
a housing;
a first button;
a second button;
a first circuit board;
a second circuit board;
an antenna, and
a device circuit board,
wherein the antenna comprises a radiator and a feeding portion, the radiator and the feeding portion are fastened together; and the first button, the second button, the first circuit board, the second circuit board, the feeding portion, and the device circuit board are all disposed inside the housing; and
in a first direction, two sides of the first circuit board are respectively connected to the first button and the device circuit board, and two sides of the second circuit board are respectively connected to the second button and the device circuit board; and, in a second direction, the second direction is perpendicular to the first direction, the first button and the second button are spaced apart, the feeding portion is disposed between the first button and the second button and electrically connected to the device circuit board, the first circuit board and the feeding portion are spaced apart, and the second circuit board and the feeding portion are spaced apart.

2. The electronic device according to claim 1, wherein, in the second direction, a distance between the first circuit board and the feeding portion is at least 0.8 millimeter, and a distance between the second circuit board and the feeding portion is at least 0.8 millimeter.

3. The electronic device according to claim 1, wherein the radiator and the feeding portion are both integrally formed with the housing, the housing comprises a border frame and a supporting piece, and the border frame surrounds and is fastened on a periphery of the supporting piece; and at least a part of the supporting piece forms the feeding portion, and at least a part of the border frame forms the radiator.

4. The electronic device according to claim 3, wherein the border frame comprises a first border frame, and at least a part of the first border frame forms the radiator;
the radiator is provided with a first through-hole and a second through-hole, and in the first direction, the first through-hole and the second through-hole both run through the radiator; and
the electronic device further comprises a first button cap and a second button cap, the first button cap is mounted into the first through-hole, and the first button cap is fastened to the first button; and the second button cap is mounted into the second through-hole, and the second button cap is fastened to the second button.

5. The electronic device according to claim 4, wherein the first button cap and the second button cap are both made of metal, and outer surfaces of the first button cap and the second button cap are both provided with an insulating layer.

6. The electronic device according to claim 4, wherein the first through-hole and the second through-hole communicate to form a communicating hole, and the first button cap and the second button cap are integrally formed.

7. The electronic device according to claim 1, wherein the supporting piece comprises a housing portion and an accommodating portion, and in the first direction, the border frame, the housing portion, and the accommodating portion are arranged sequentially; and the housing portion comprises a first housing portion and a second housing portion, and in the second direction, the first housing portion, the feeding portion, and the second housing portion are arranged sequentially; and
the first button is disposed in the first housing portion, the second button is disposed in the second housing portion, and the device circuit board is disposed in the accommodating portion.

8. The electronic device according to claim 7, wherein the supporting piece further comprises a connective portion, and in the first direction, the border frame, the connective portion, and the feeding portion are connected sequentially;
in the second direction, a surface of the first housing portion, a surface of the connective portion, and a surface of the second housing portion are connected sequentially and are flush with each other, to form a sealing surface; and the electronic device further comprises a sealing piece, and
a surface of a side of the sealing piece is connected to the sealing surface.

9. The electronic device according to claim 7, wherein the first circuit board is a flexible circuit board, and the first circuit board comprises a first connecting portion, a first flexible portion, and a second connecting portion that are connected sequentially; and
the first connecting portion is disposed in the first housing portion, and the second connecting portion is disposed in the accommodating portion; in the first direction, the first connecting portion and the first button are stacked and connected; and in a thickness direction of the electronic device, the second connecting portion and the device circuit board are stacked and connected.

10. The electronic device according to claim 9, wherein the first housing portion is provided with a first housing groove, and the first connecting portion and the first button are both disposed in the first housing groove; and
the electronic device further comprises a first reinforcing plate, the first reinforcing plate is disposed in the first housing groove, a surface of the first reinforcing plate is stacked on and connected to a surface of the first connecting portion and that faces away from the first button, and a surface of the first reinforcing plate and that faces away from the first connecting portion is fastened to a groove side of the first housing groove.

11. The electronic device according to claim 10, wherein a first fixing protrusion protrudes from a side of the first reinforcing plate and that is located at an opening of the first housing groove, and a first fixing groove is recessed into the groove side of the first housing groove; and
the first fixing protrusion is fastened into the first fixing groove, to restrict the first reinforcing plate from shifting in the second direction.

12. The electronic device according to claim 10, wherein a second fixing protrusion protrudes from a side of the first reinforcing plate and that faces a groove bottom of the first housing groove, the groove bottom of the first housing groove is provided with a first fixing hole, and a second fixing groove is recessed into a hole wall of the first fixing hole; and the second fixing protrusion extends into the first fixing hole and is fastened into the second fixing groove, to restrict the first reinforcing plate from shifting in the thickness direction.

13. The electronic device according to claim 9, wherein the accommodating portion is provided with an accommodating cavity, a first accommodating groove is recessed into a cavity bottom of the accommodating cavity, the device circuit board is disposed in the accommodating cavity, and the second connecting portion is disposed in the first accommodating groove.

14. The electronic device according to claim 13, wherein the electronic device further comprises a second reinforcing plate, the second reinforcing plate is disposed in the first accommodating groove, and the second reinforcing plate is stacked on a surface of the second connecting portion and that faces away from the device circuit board.

15. The electronic device according to claim 7, wherein the second circuit board is a flexible circuit board, and the second circuit board comprises a third connecting portion, a second flexible portion, and a fourth connecting portion that are connected sequentially; and
the third connecting portion is disposed in the second housing portion, and the fourth connecting portion is disposed in the accommodating portion; in the first direction, the third connecting portion and the second button are stacked and connected; in a third direction, the fourth connecting portion and the device circuit board are stacked and connected; and the third direction is perpendicular to the first direction, and the third direction is perpendicular to the second direction.

16. The electronic device according to claim 15, wherein the second housing portion is provided with a second housing groove, and the third connecting portion and the second button are both disposed in the second housing groove; and
the electronic device further comprises a third reinforcing plate, the third reinforcing plate is disposed in the second housing groove, a surface of the third reinforcing plate is stacked on and connected to a surface of the third connecting portion and that faces away from the second button, and a surface of the third reinforcing plate and that faces away from the third connecting portion is fastened to a groove side of the second housing groove.

17. The electronic device according to claim 16, wherein a third fixing protrusion protrudes from a side of the third reinforcing plate and that is located at an opening of the second housing groove, and a third fixing groove is recessed into the groove side of the second housing groove; and the third fixing protrusion is fastened into the third fixing groove, to restrict the third reinforcing plate from shifting in the second direction.

18. The electronic device according to claim 16, wherein a fourth fixing protrusion protrudes from a side of the third reinforcing plate and that faces a groove bottom of the second housing groove, the groove bottom of the second housing groove is provided with a second fixing hole, and a fourth fixing groove is recessed into a hole wall of the second fixing hole; and the fourth fixing protrusion extends into the second fixing hole and is fastened into the fourth fixing groove, to restrict the third reinforcing plate from shifting in the third direction.

19. The electronic device according to claim 15, wherein the accommodating portion is provided with an accommodating cavity, a second accommodating groove is recessed into a cavity bottom of the accommodating cavity, the device circuit board is disposed in the accommodating cavity, and the fourth connecting portion is disposed in the second accommodating groove.

20. The electronic device according to claim 19, wherein the electronic device further comprises a fourth reinforcing plate, the fourth reinforcing plate is disposed in the second accommodating groove, and the fourth reinforcing plate is stacked on a surface of the fourth connecting portion and that faces away from the device circuit board.
